(19) United States
(12) Patent Application Publication
(10) Pub. No.: US 2022/0299860 A1
(43) Pub. Date: Sep. 22, 2022

(54) EXTENSIVIEW AND ADAPTIVE LKA FOR ADAS AND AUTONOMOUS DRIVING

(71) Applicant: Shanghai Jun Kai Technology LLC, Shanghai (CN)

(72) Inventors: Jinsong WANG, Troy, MI (US); Bin CHEN, Ames, IA (US)

(21) Appl. No.: 17/619,080

(22) PCT Filed: Jun. 25, 2020
(86) PCT No.: PCT/US2020/039531

§ 371 Date: Dec. 14, 2021

Related U.S. Application Data
(60) Provisional application No. 62/866,409, filed on Jun. 25, 2019.

(51) Int. Cl. G03B 37/00; B60W 30/12; H04N 5/232; G06V 20/58; G06V 10/147; H04N 5/225; G03B 17/17

(52) U.S. Cl. CPC G03B 37/00; B60W 30/12; H04N 5/23238; G06V 20/58; G06V 10/147; H04N 5/2254; G03B 17/17; B60W 2420/42; H04N 5/247

(57) ABSTRACT

A system and method for assisted driving include an extensive view sensor and an adaptive lane keeping assistant to detect traffic information in front of a leading vehicle based upon sensors mounted on sides of a host vehicle. The sensors may be cameras, radars, or LiDAR units. The sensors are side placed so that they can minimize the blocked view area. In order to achieve better view of the traffic in front of the leading vehicle, aLKA is also presented to adjust the lateral position of the host vehicle relative to the leading vehicle. Based on the detected information, the host vehicle can predict the traffic changes and prepare ahead of time.

### CROSS-REFERENCE TO RELATED APPLICATIONS

The present application claims priority from U.S. provisional patent application No. 62/866,409 filed on Jun. 25, 2019, incorporated herein by reference.

### TECHNICAL FIELD

The present disclosure relates to advanced driver assistance systems, and more particularly to lane keeping assistant technology.

### BACKGROUND

Advanced driver-assistance systems (ADAS) are designed to reduce accident rates and make driving safer by aiding a human driver in driving. A few well-known ADAS in production include forward collision warning (FCW), automatic emergency brake (AEB), adaptive cruise control (ACC). Many current ADAS utilize a center mounted camera (e.g., Mobileye) and/or a radar sensor to detect and track objects in front of the vehicle, enabling the ADAS to give warnings or to control the vehicle to slow down or stop once a collision threat is detected.

FIGS. 1 and 2 illustrate that, much like human drivers, these center-mounted sensors may have a blocked view and/or blind zone 4 when there is a leading vehicle. The blind zone 4 can result in missed-detection, missed-tracking, or late-detection of potentially threatening objects or events. As illustrated in FIG. 1, the blind zone may cover the entire area of the lane in which the host vehicle 1 and the leading vehicle 2 are located, in front of the leading vehicle 2. The blind zone 4 may also include areas of other lanes in front of the leading vehicle 2. FIG. 2 illustrates how damaging the blind zone 4 can be to the efficacy of the sensors: an oncoming vehicle, a stopped vehicle, and a bicycle located in three different lanes are all within the blind zone 4. An example of the damage that may be caused by the blind zone 4 is a series collision. If a leading vehicle hits its brakes hard, since the view of the following vehicles are blocked, human drivers and/or ADAS controlling the following vehicles may not have enough warning time to respond to the sudden deceleration of the leading vehicle and any subsequent traffic. Note that ADAS also require a minimum time for responding. Another example of the limitations of current systems is potentially unsafe passing, as shown in FIG. 2. Since the view of the center-mounted sensor is blocked by the leading vehicle, the following vehicle is not aware of the traffic in the next lanes and that it is unsafe to pass the leading vehicle.

### SUMMARY

The present disclosure presents an imaging technology called Extensiview and an adaptive lane keeping assistant (aLKA) which incorporates Extensiview. The technology disclosed herein helps a host vehicle to detect the traffic in front of a leading vehicle through side mounted sensors, which minimize or eliminate the blind zone of the host vehicle, as shown in FIG. 1. Therefore, based on the detection and tracking information, the host vehicle is able to predict the upcoming traffic conditions, which gives the host vehicle potentially crucial extra time to prepare for responding to any sudden or hidden traffic changes. As a result, this technology is able to improve driving safety, driving comfort, and potentially fuel economy.

An exemplary embodiment of the system includes sensors placed on both sides of a host vehicle. The side-placed sensors may be cameras, radar units, or light detection and ranging (LiDAR) units. FIG. 3 shows the difference in field of view (FOV) between side-placed sensors and center-mounted sensors. Sensors placed on both sides of a vehicle can cover more blind view areas. The present disclosure focuses on using surround-view side cameras, which may be installed underneath the rear-view mirrors of a vehicle. If a surround-view camera system has been implemented on a vehicle, the presently disclosed technology may be applied without adding extra camera hardware and without significant additional cost. FIG. 4 shows the FOV of exemplary surround-view side cameras. Note that the surround-view side cameras used in this example are wide-angle or fisheye cameras, but that other types and configurations may be used in alternate embodiments.

This exemplary embodiment also includes a vehicle lane keeping algorithm. Traditional lane keeping assist (LKA) systems utilize the lane sensing result to keep a vehicle within a lane. Most of the time, the goal of traditional LKA systems is to keep the vehicle close to the lane center. As discussed above, the lane keeping method presented in this disclosure is called adaptive lane keeping assistant (aLKA). In order to cover more of the blocked view with side-camera extensive views (e.g., Extensiview), it is desirable to adaptively position the host vehicle off-center of the leading vehicle, but still keep within the lane to maintain safety. FIG. 5 illustrates the benefit of aLKA for minimizing blind zones.

As soon as side sensors detect an object, the perception algorithm will classify the object, and calculate the distance of the object from the vehicle, and calculate the velocity of the object. If the object is a vehicle, especially a leading vehicle, the perception algorithm can also detect illuminated brake lights, which can be a critical indication of imminent traffic speed change. The detected information will be sent to a vehicle controller so that the host vehicle can predict the coming traffic. The detected information can be displayed on an infotainment screen as a method of reminding drivers. The predicted information can be integrated with an AEB system for safety handling or integrated with a vehicle powertrain system to optimize the power output. As a result, the aLKA and the Extensiview system may not only improve driving safety, but may also improve driving comfort and potentially improve vehicle energy efficiency.

A system and method for assisted driving include an Extensiview sensor and an aLKA to detect traffic information in front of a leading vehicle based upon sensors mounted on sides of a host vehicle. The sensors may be cameras, radar sensors, or LiDAR units. The sensors are side placed so that they can minimize the blocked view area. In order to achieve a better view of the traffic in front of the leading vehicle, an aLKA is presented to adjust the lateral position of the host vehicle relative to the leading vehicle. Based on the detected information, the host vehicle can predict the traffic changes and prepare ahead of time.

### BRIEF DESCRIPTION OF THE DRAWINGS

FIG. 1 is a schematic diagram illustrating a traditional host vehicle's field of view and a view/zone blocked by a leading vehicle or obstacle. Here, \textcircled{1} is the host vehicle, \textcircled{2} is the leading vehicle or obstacle, \textcircled{3} is a normal field of view of the host vehicle if there were no obstruction, and \textcircled{4} is a blocked view/zone of the host vehicle caused by the leading vehicle or obstacle.

FIG. 2 is a schematic diagram showing that traditional technology may have a large blocked view which increases the chance of accidents, such as series collisions, unsafe passes, or the like. Here, \textcircled{1} is the host vehicle, \textcircled{2} is a normal field of view of the host vehicle, \textcircled{3} is a blocked view/zone of the host vehicle, and \textcircled{4} represents traditionally uninformed passing trajectories of the host vehicle.

FIG. 3 is a schematic diagram illustrating a field of view (FOV) comparison between side-placed sensors and center-mounted sensors. Here, \textcircled{1} is the host vehicle, \textcircled{2} is a field of view of center-mounted sensors, \textcircled{3} is a field of view of side-placed sensors, and \textcircled{4} is a blocked view/zone of the center mounted sensors.

FIG. 4 is a schematic diagram showing a FOV of surround-view side cameras. Here, \textcircled{1} is the host vehicle, \textcircled{2} is a field of view of surround-view side cameras, \textcircled{3} is a field of view of center mounted sensors, and \textcircled{4} is a blocked view/zone of the center mounted sensors.

FIG. 5 is a schematic diagram demonstrating an application of an exemplary adaptive lane keeping assistant (aLKA) for minimizing blind zones on a straight road. Here, \textcircled{1} is the host vehicle, \textcircled{2} is the leading vehicle, \textcircled{3} is the vehicle to be detected, which is in front of the leading vehicle \textcircled{2}, \textcircled{4} is the center line of the leading vehicle, \textcircled{5} is a FOV of center-mounted sensors, and \textcircled{6} is a FOV of side-placed sensors.

FIG. 6 is a schematic diagram illustrating an application of an exemplary aLKA for maximizing the extensive view on curvy road. Here, \textcircled{1} is the host vehicle, \textcircled{2} is a FOV of center-mounted sensors, and \textcircled{3} is a FOV of side-placed sensors.

FIG. 7 is a photograph illustrating a test result comparison between surround-view side cameras versus surround-view center cameras and center roof-mounted cameras. Here, \textcircled{1} is a view from the surround-view center forward camera, \textcircled{2} is a view captured by front center roof mounted camera, \textcircled{3} is a view of the surround-view left side camera, \textcircled{4} is a view captured by the surround-view right side camera, \textcircled{5} and \textcircled{6} are the forward-looking like images converted (i.e., de-warped and projected) from parts of the images in \textcircled{3} and \textcircled{4}, and \textcircled{7} is a traditionally hidden vehicle.

FIG. 8 is a flowchart outlining an integrated Extensiview and aLKA system.

FIG. 9 is a photo demonstrating an exemplary test result of using Extensiview for object detection. Here, \textcircled{1} is the view from a center forward camera, \textcircled{2} and \textcircled{3} are the forward-looking like images converted from the images captured by surround-view side cameras. \textcircled{4} and \textcircled{5} outline the detected objects by surround-view side cameras, and \textcircled{6} highlights the vehicle in front of the leading vehicle, detected by the surround-view right side camera, where neither the front center camera nor the driver would be able to see it.

FIG. 10 is a schematic diagram illustrating the field of view of an exemplary Extensiview system.

FIGS. 11A-11D are schematic diagrams illustrating exemplary camera assemblies which may be used in Extensiview systems.

FIGS. 12A-12D are photographs illustrating prototypes of the exemplary camera assemblies.

FIGS. 13A-13C are photographs illustrating prototypes of the exemplary camera assemblies arranged in a vehicle.

FIGS. 14A-14B are photographs illustrating visual input received by the exemplary camera assemblies.

FIG. 15 is a schematic diagram illustrating a stereo-view system.

FIGS. 16A-16B are schematic diagrams illustrating exemplary camera assemblies which may be used in Extensiview systems.

FIGS. 17A-17C are schematic diagrams illustrating the FOVs of exemplary camera assemblies.

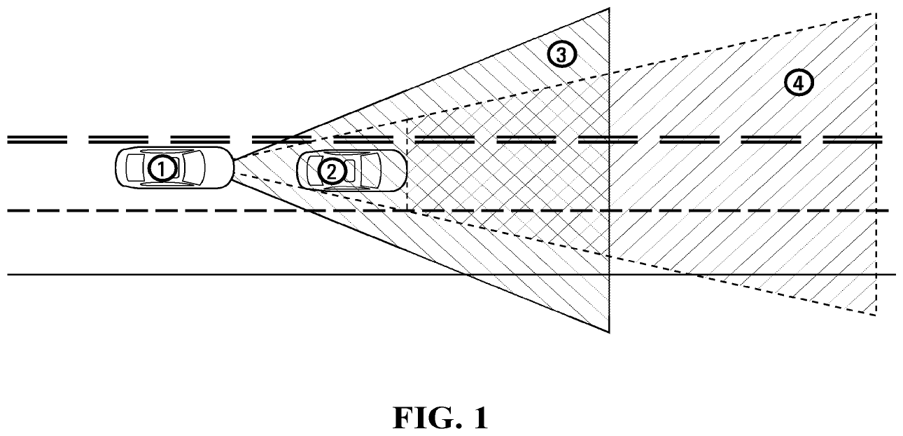

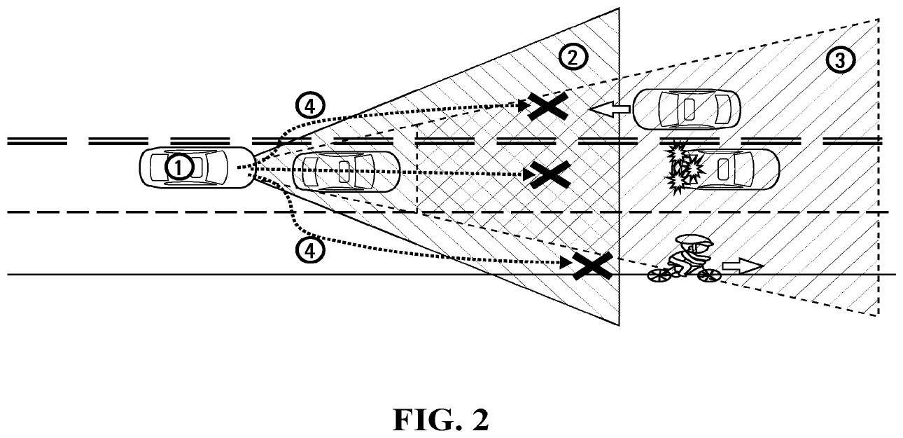

### DETAILED DESCRIPTION

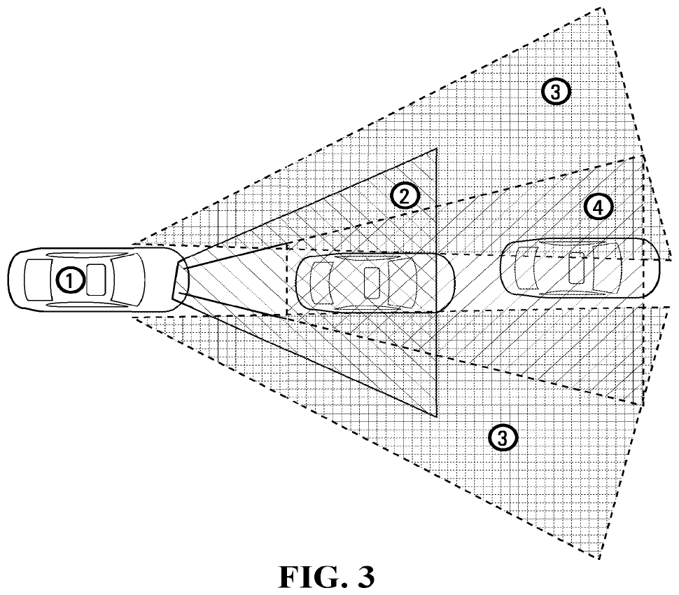

As discussed above, human drivers and center-mounted sensors controlling a host vehicle often have a relatively large blocked view/zone when the host vehicle is located behind a leading vehicle or obstacle. The present disclosure presents a vision technology called Extensiview and an aLKA incorporating Extensiview for minimizing the blocked zone and detecting the traffic in front of a leading vehicle. It should be noted that the vision technology disclosed herein is referred to as Extensiview; however, one skilled in the art will recognize that the systems and methods of the present disclosure may be implemented using any similar technology known in the art without departing from the scope of the disclosure. Instead of using center-mounted sensors, Extensiview may use sensors placed on both sides of a host vehicle, which, as shown in FIG. 3, are able to cover more blocked view areas so that more traffic information can be perceived. The traffic information may be vehicles, pedestrians, bicyclists, potholes or rocks on the road, or other obstacles present around the host vehicle. Also, the traffic information is not limited to the single lane where the host vehicle is driving, but may also include information about traffic in neighboring lanes, which is also important. For example, when a vehicle in the neighboring lane sees a big rock in his lane, that vehicle may have high probability of changing lanes, which, in turn, may affect the traffic flow of the lane where the host vehicle is driving. Such information is very useful in controlling the host vehicle, whether the host vehicle is a human driven vehicle or an autonomous vehicle. Based upon such information, the driver of the host vehicle, or the virtual driver or autonomous driving system of the host vehicle, may be provided an opportunity to predict the coming traffic change and prepare ahead of time.

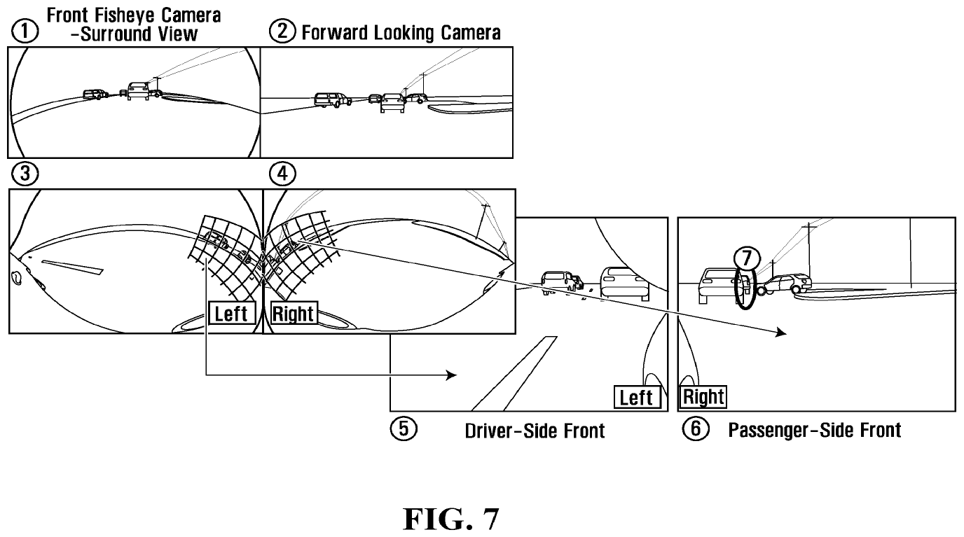

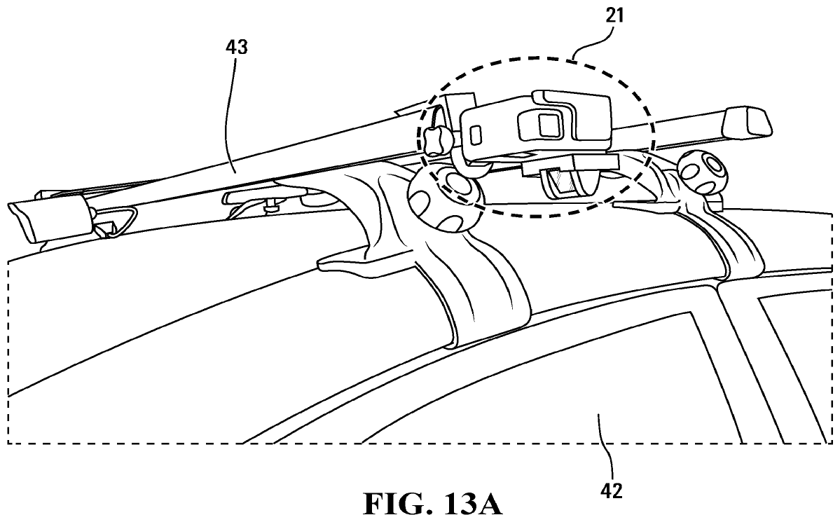

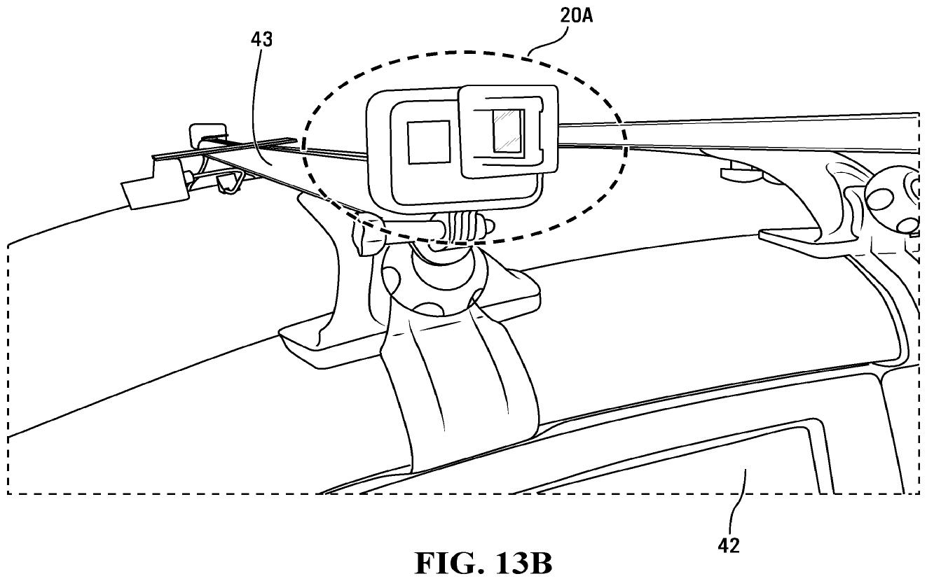

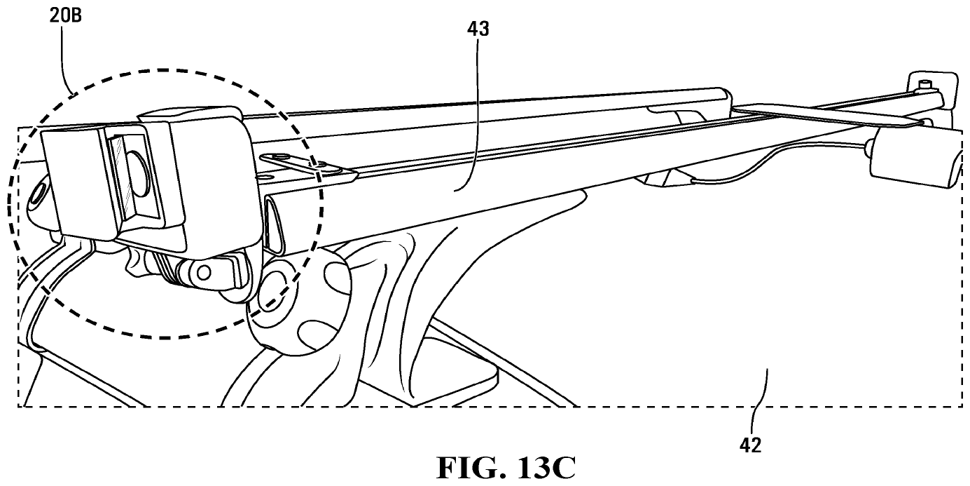

The sensors mounted on the host vehicle may be, but are not limited to, cameras, radars, or LiDAR units. In some embodiments, each of the sensors may be a front-facing or a wide-angle camera. FIGS. 13A-13C illustrate exemplary cameras arranged in a vehicle. The facing direction of the each of the sensors may be determined based on sensor characteristics. For example, a narrow field of view camera may be arranged to faceforward. A wide-angle camera, such as surround-view fisheye camera, may be arranged at an angle, such that it does not face forward. One of the possible benefits of using surround-view cameras is that it might allow a full view to be achieved without adding extra hardware parts and costs where such cameras are pre-installed. Another important benefit of using surround-view cameras is that the side downward facing surround-view cameras might not accumulate dirt as readily as outside-mounted forward-facing sensors. FIG. 7 illustrates a comparison between surround-view center cameras vs surround-view side cameras.

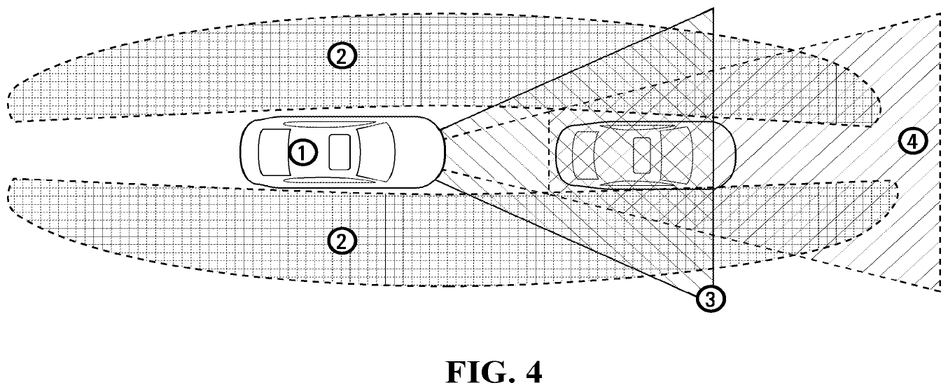

FIGS. 3 and 4 show schematic representations of the FOV of side mounted front-facing sensors and side mounted surround view sensors, respectively. As shown in FIG. 3, a front-facing camera mounted on the side of a host vehicle 1, may provide a FOV 3 extending in front of and to the side of the host vehicle 1. Unlike the FOV 2 of a center mounted sensor which may experience a blind zone 4, the FOV 3 of the side-mounted sensors may not be blocked by a leading vehicle. As shown in FIG. 3, a side mounted front facing sensor may be able to detect a vehicle in front of the leading vehicle, while a center mounted sensor may not be able to do so. As shown in FIG. 4, a surround view camera mounted on the side of a host vehicle 1 may provide a FOV 2 extending in front of, to the side of, and behind the host vehicle 1. These cameras may also not experience blind spots.

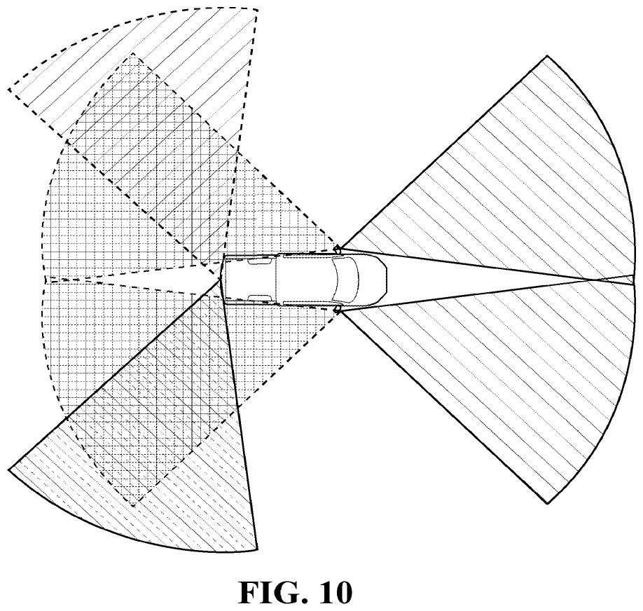

FIG. 10 shows a schematic representation of the FOV of a host vehicle 1 having multiple sensors mounted thereon. The host vehicle 1 may include two front facing cameras and two rear facing cameras mounted near its rear-view mirrors. The front facing cameras may have FOVs 12a, 12b which overlap at a point in front of the host vehicle 1. The rear facing cameras may have FOVs 13a, 13b which overlap at a point behind the host vehicle 1. These FOVs 13a, 13b may also cover regions to the sides of the host vehicle 1. The host vehicle 1 may have additional cameras mounted near the rear license plate which provide wider FOVs 14a, 14b in the area behind the vehicle, and may, for example, cover lanes to the side of the lane in which the host vehicle 1 is located.

In general, FIG. 10 shows that cameras or other sensors may be disposed around the host vehicle 1 to provide a complete overall FOV. In some embodiments, additional cameras or sensors may be added to the system to provide additional FOVs. In particular, sensors/cameras which are directed downwards or backwards may be used. The specific cameras/sensors used, and the positioning of those sensors may be determined based on the properties of the host vehicle 1 and the driving situations which it is likely to experience. In some embodiments, it may be possible to reposition the cameras/sensors on the host vehicle 1 and/or add cameras/sensor to a host vehicle 1 at different times while maintaining the same system controller.

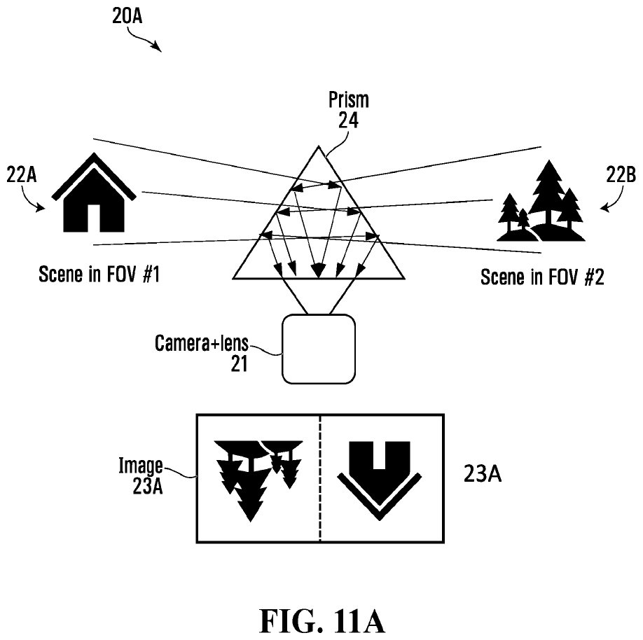

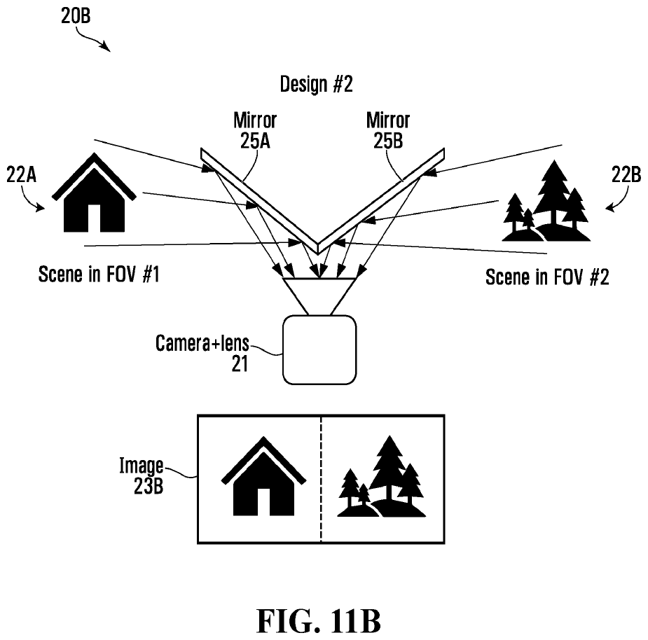

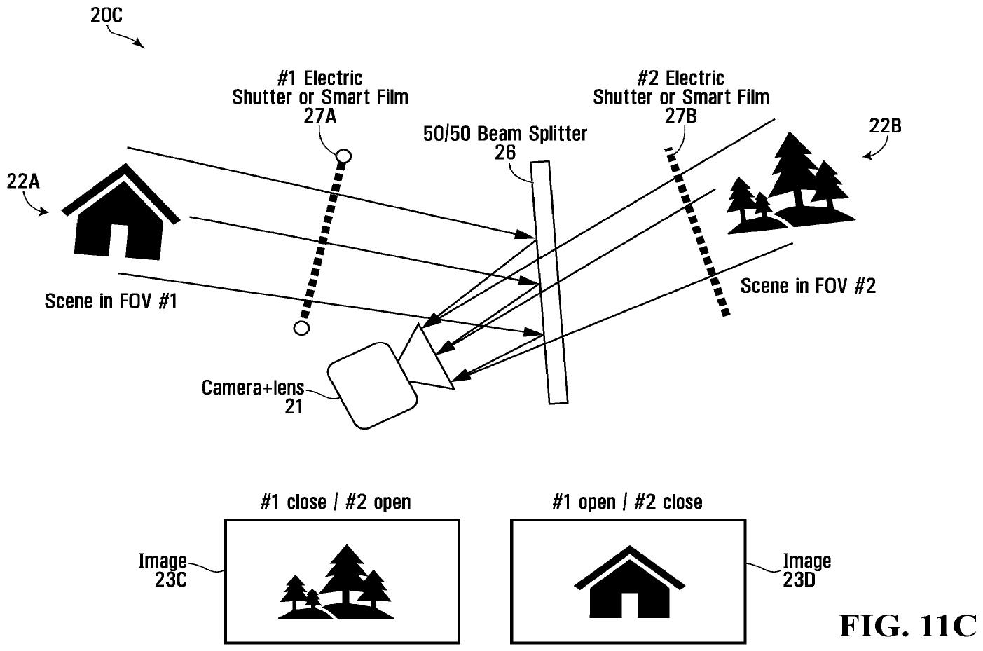

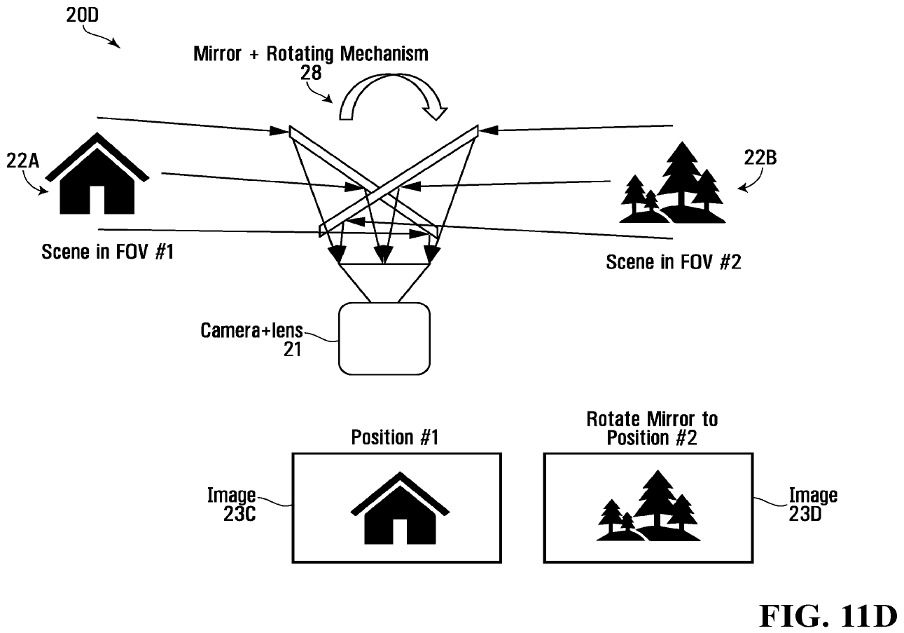

In some embodiments, the sensors mounted on the host vehicle may be camera assemblies, as illustrated in FIGS. 11A-11D. The camera assemblies may have expanded FOVs compared to independent cameras. This may allow a system to use a camera assembly to view both sides of a host vehicle, instead of having to use separate cameras to view each side of the host vehicle 1. The camera assemblies may reduce the cost and complexity of implementing the systems disclosed herein.

The camera assemblies shown in FIGS. 11A-11D may be mounted on the top of a host vehicle (not shown). In some embodiments, they may be mounted near the front of the host vehicle or near the rear of the host vehicle. In some embodiments, the camera assemblies may include a self-cleaning function, which may improve their functionality when located on the top of a vehicle. In some embodiments, the camera or camera assembly may have a binocular function.

FIG. 11A illustrates a camera assembly 20A comprising a camera 21 and a prism 24. According to the present disclosure, a prism may comprise a transparent object with polygonal or oval sides. In particular, the present disclosure may make use of triangular and triangular pyramid prisms. The prisms may or may not have refracting surfaces. The prism 24 may allow the camera 21 to view scenes 22A, 22B from two sides. In some embodiments, the prism 24 may allow the camera 21 to see scenes from the front and/or the rear as well. The shape of the full FOV may depend on the properties of the camera 21 and the prism 24. In some embodiments, the FOV may resemble a combination of both side-camera FOVs 3 shown in FIG. 3. The camera 21 may record an image 23A showing the two scenes 22A, 22B side-by-side and upside-down. A controller (not illustrated) of the Extensiview system may process this image to detect obstacles and to determine where the obstacles are located in relation to the host vehicle.

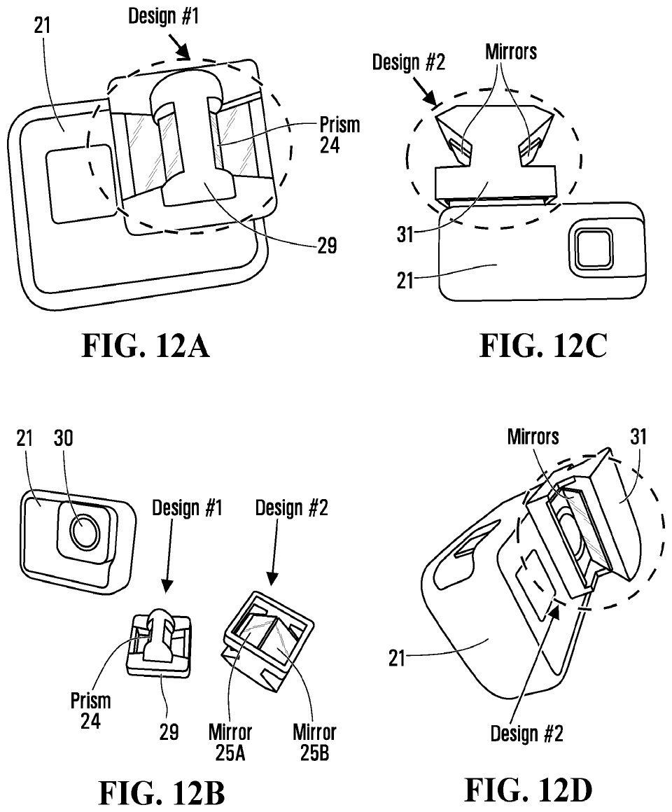

FIGS. 12A and 12B show a prototype of a prism 24 which may be mounted on a camera 21. The prism 24 may be housed in a casing 29 which allows it to be mounted on the camera 21. The prism 24 may be fitted to a lens 30 of the camera 21, such that it controls the light entering the lens 30.

FIG. 11B illustrates a camera assembly 20B comprising a camera 21 and a pair of mirrors 25A, 25B. The mirrors 25A, 25B may be disposed at an angle to each other. The mirrors 25A, 25B may allow the camera 21 to view scenes 22A, 22B from two sides. The shape of the full FOV may depend on the properties of the camera 21 and the mirrors 25A, 25B. In some embodiments, the FOV may resemble a combination of both side-camera FOVs 3 shown in FIG. 3. The camera 21 may record an image 23B showing the two scenes 22A, 22B side-by-side and right-side-up. A controller (not illustrated) of the Extensiview system may process this image to detect obstacles and to determine where the obstacles are located in relation to the host vehicle.

FIGS. 12B, 12C, and 12D show a prototype of a pair of mirrors 25A, 25B which may be mounted on a camera 21. The mirrors 25A, 25B may be housed in a casing 31 which holds them at an angle to each other and allows them to be mounted on the camera 21. The mirrors 25A, 25B may be fitted to a lens 30 of the camera 21, such that they control the light entering the lens 30.

In some embodiments, three or more mirrors may be used with the camera assembly 20B. The mirrors may be arranged such that the two side views 22A, 22B are visible to the camera 21, as well as a front scene, back scene, lower scene, or other scene. The scenes may all be visible to the camera 21 in a side-by-side image and the controller may be configured to process however many scenes are present in the image.

FIG. 11C illustrates a camera assembly 20C comprising a camera 21, a beam splitter 26, and a pair of shutters 27A, 27B. The mirrors beam splitter 26 may allow the camera 21 to view scenes 22A, 22B from two sides. The shape of the full FOV may depend on the properties of the camera 21 and the beam splitter 26. In some embodiments, the FOV may resemble a combination of both side-camera FOVs 3 shown in FIG. 3. The shutters 27A, 27B may open and close such that only one scene 22A, 22B is visible to the camera 21 at a given time. The shutters 27A, 27B may be any type of shutter or film known in the art which can open and close. The shutters 27A, 27B may open and close rapidly so that the camera 21 can see both scenes 22A, 22B in real time. The camera 21 may record a series of alternating images 23C, 23D showing the two scenes 22A, 22B. A controller (not illustrated) of the Extensiview system may process the series of images 23C, 23D to detect obstacles and to determine where the obstacles are located in relation to the host vehicle.

FIG. 11D illustrates a camera assembly 20D comprising a camera 21, a mirror 28, and a rotating mechanism (not illustrated). The mirror 28 may be oriented at an angle. The mirror 28 and the rotating mechanism may allow the camera 21 to view scenes 22A, 22B from two sides. The shape of the full FOV may depend on the properties of the camera 21 and the mirror 28. In some embodiments, the FOV may resemble a combination of both side-camera FOVs 3 shown in FIG. 3. In some embodiments, the FOV may also include a front view and/or a back view. The camera 21 may record a series of alternating images 23C, 23D showing the two scenes 22A, 22B, depending on the orientation of the mirror 28 as controlled by the rotating mechanism. A controller (not illustrated) of the Extensiview system may process the series of images 23C, 23D to detect obstacles and to determine where the obstacles are located in relation to the host vehicle.

In some embodiments, the prism, mirror, and other elements shown in FIGS. 11A-11D may be incorporated into a camera, such that the camera has the same functionality as the camera assemblies discussed above.

One skilled in the art will recognize that other hardware could be used to allow a camera to collect visual input from multiple views. For example, the assembly could include a fish-eye or wide angle lens which collects one image including many or all views surrounding the camera. In such embodiments, the entire image may be used to identify obstacles, or the image may be processed to separate out particular views before identifying obstacles in those views. A camera assembly in accordance with the present disclosure may include any means of collecting multiple views known in the art.

FIGS. 13A-13C illustrate cameras/camera assemblies mounted on host vehicles. FIG. 13A illustrates a camera 21 mounted on a host vehicle 42. The camera 21 may be mounted on the roof of the vehicle 42 proximate a side of the vehicle 42. In some embodiments, a roof mounting system 43 may be used to mount the camera 21. FIGS. 13B and 13C show a camera assembly 20A according to FIG. 11A and a camera assembly 20B according to FIG. 11B mounted on the host vehicle 42 in a similar fashion. As shown in FIGS. 13B and 13C, the camera assemblies 20A, 20B may capture a forward scene in front of the host vehicle 42 and a rearward scene behind the host vehicle 42. The camera assemblies 20A, 20B could be rotated ninety degrees to capture two side views as described in FIGS. 11A-11D. As shown in FIG. 13B, the camera/camera assembly may be connected to a power source within the vehicle.

The cameras/camera assemblies may be mounted on the host vehicle such that they collect visual input from one or more blind spots of the host vehicle. A blind spot may be any area that a driver and/or a center mounted sensor cannot see. This may enable the cameras/camera assemblies to provide additional information to the vehicle or operator to make better driving decisions and to thereby improve the safety of the vehicle.

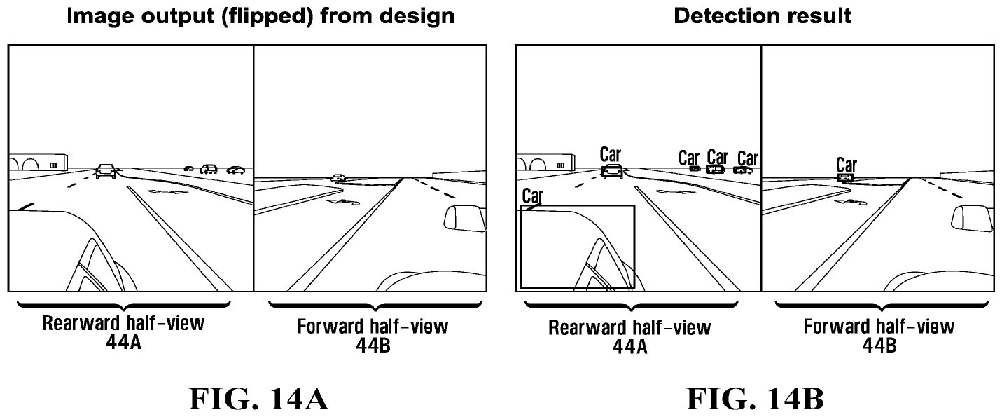

FIGS. 14A-14B illustrate an image that may be captured by the camera assembly 20B shown in FIG. 13C. FIG. 14A shows the rearward scene 44A shown side-by-side with the forward scene 44B. FIG. 14B shows a processed image 45 in which obstacles have been detected.

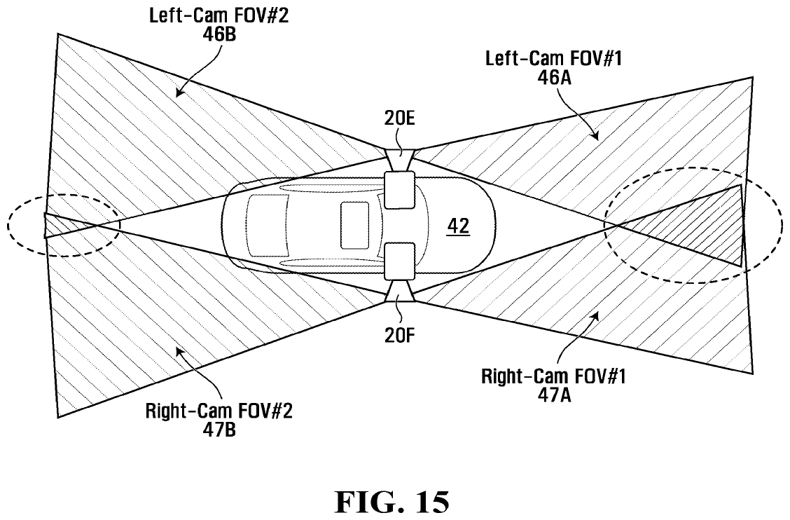

FIG. 15 is a schematic view of the FOVs achieved by two camera assemblies 20E, 20F mounted on the sides of a host vehicle 42. The camera assemblies 20E, 20F may be in accordance with any of the camera assemblies 20A-20D described above. The first camera assembly 20E may have a two-portion FOV 46A, 46B which extends in front of and behind the host vehicle 42. The second camera assembly 20F may have a mirrored two-portion FOV 47A, 47B. When the camera assemblies 20E, 20F are mounted on both-side of the vehicle 42 as extensiview configuration, the FOVs on the driver-side and FOVs on the passenger-side have FOV overlaps. These create the stereo-vision configuration for the forward (and backward) overlapping FOV regions, which gives accurate and robust depth sensing and hence the distance measurement for objects.

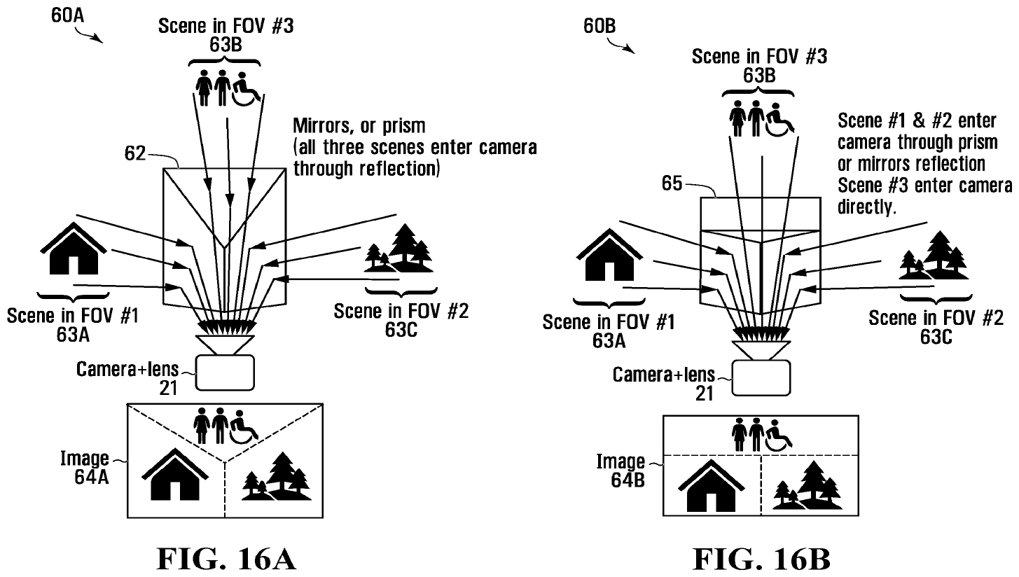

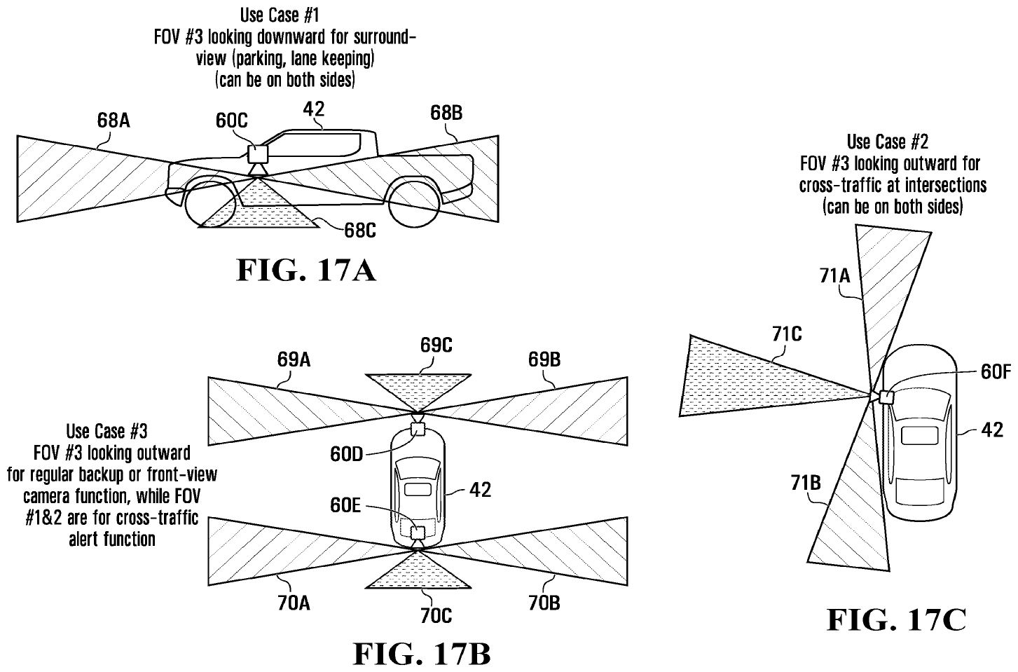

FIGS. 16A-16B and 17A-17C illustrate camera assemblies which provide a view in three directions. In some embodiments, these systems may provide a front view, a rear view, and a downward view. One skilled in the art will recognize that with minor modifications, they could provide side views and/or other views instead of or in addition to the illustrated views. Such modifications fall within the scope of the present disclosure. The camera assemblies may be considered to have three FOVs or to have FOVs which extend in three directions.

FIG. 16A illustrates a camera assembly 60A comprising a camera 21 and a prism/mirror assembly 62. The prism/mirror assembly 62 reflects light from three directions into a lens of the camera 21. This allows the camera 21 to detect scenes 63A, 63B, 63C from three regions. The camera may view the scenes 63A, 63B, 63C in a single image 64A. A controller of the system may be configured to process the image 64A to detect obstacles and to determine where the obstacles are located relative to the host vehicle.

FIG. 16B illustrates a camera assembly 60A comprising a camera 21 and a prism/mirror assembly 65. The prism/mirror assembly 65 reflects light from two directions into a lens of the camera 21. The prism/mirror assembly 65 is configured such that the lens of the camera may also capture light directly. This allows the camera 21 to detect scenes 63A, 63B, 63C from three regions. The camera may view the scenes 63A, 63B, 63C in a single image 64B. A controller of the system may be configured to process the image 64A to detect obstacles and to determine where the obstacles are located relative to the host vehicle.

FIGS. 17A-17C are schematic diagrams illustrating camera assemblies in accordance with FIG. 16A or 16B mounted on host vehicles. As the Figures show, each camera assembly provides a FOV which has three regions extending in three directions. The camera assemblies can be oriented differently to view different regions of interest. In some embodiments, it may be possible to reorient the camera assemblies during use depending on the particular driving situation a host vehicle is used in.

17A illustrates a camera assembly 60C mounted proximate a wing mirror of the host vehicle 42. The camera assembly 60C provides a three-region FOV 68A, 68B, 68C, which extends forward, backward, and downward. Such an orientation may be useful for parking and lane-keeping.

FIG. 17B illustrates a camera assemblies 60D, 60E mounted proximate the front and rear of the host vehicle 42. Each camera assembly 60D, 60E provides a three-region FOV 69A-69C, 70A-70C which extends to either side and either forward or backward. Such an orientation may back-up, regular driving, or cross-traffic alert functions.

FIG. 17C illustrates a camera assembly 60F mounted proximate a wing mirror of the host vehicle 42. The camera assembly 60C provides a three-region FOV 68A, 68B, 68C, which extends forward, backward, and side-ward. Such an orientation may be useful for looking for cross-traffic at intersections. One will note that the difference between the configuration shown in FIG. 17A and the configuration shown in FIG. 17C may merely be the orientation of the camera assembly.

In order to achieve a more extensive view of traffic in front of the host vehicle, a technology called adaptive lane keeping assistant (aLKA) is proposed in this disclosure. Traditional lane keeping assistants (LKA) may utilize lane sensing results for lateral control to keep the vehicle within the lane. Because the only goal of LKA is to keep the host vehicle within the lane, vehicles using LKA are usually maintained toward to lane center.

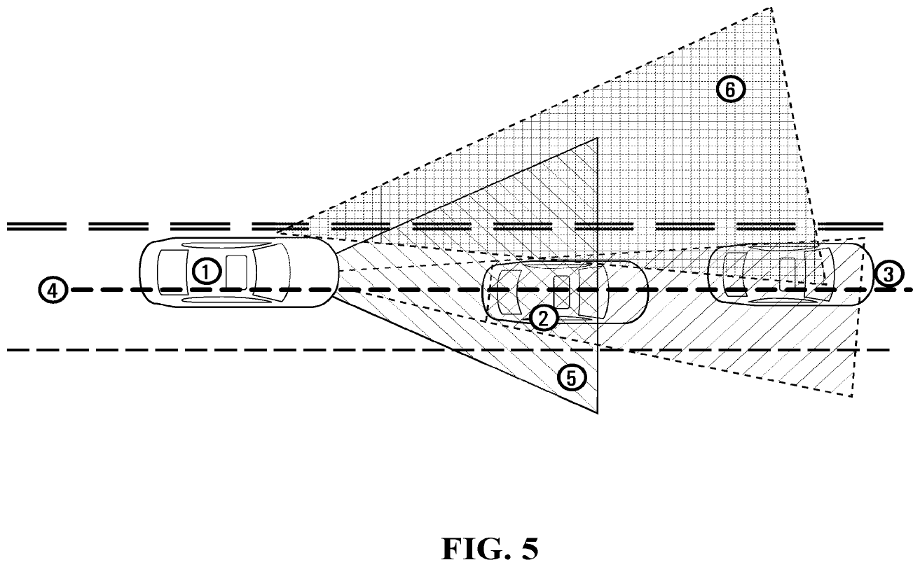

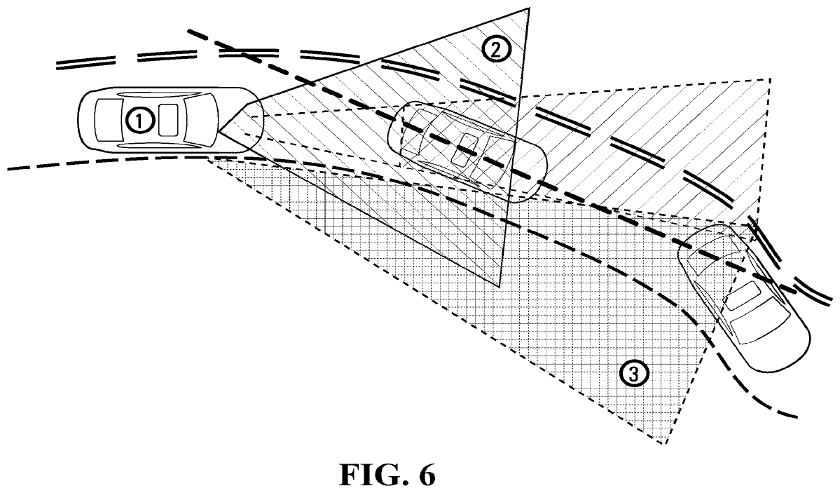

The goal of the aLKA of the present disclosure is not only to keep the host vehicle within the lane, but also to position the host vehicle toward the maximum safe and allowable side limit of the lane. The maximum allowable side limit may be determined based on the surrounding traffic conditions as well as the actual need. For example, if the leading vehicle has small width, aLKA may not need to position the vehicle near the lane marker. Or if there are vehicles nearby in the next lanes, then, the maximum allowable side limit may be smaller than the cases without vehicles in adjacent lanes. The decision about whether to position the host vehicle to the right or left side limit may depend on the position of a leading vehicle in the lane and/or the road curvature direction in curved road scenarios. In general, the aLKA may position the host vehicle off-center of the leading vehicle as much as needed to cover more center sensor or driver blocked view area with side mounted sensors' FOV. FIGS. 5 and 6 illustrate two use cases of applying aLKA for Extensiview. FIGS. 5 and 6 will be described in more detail below.

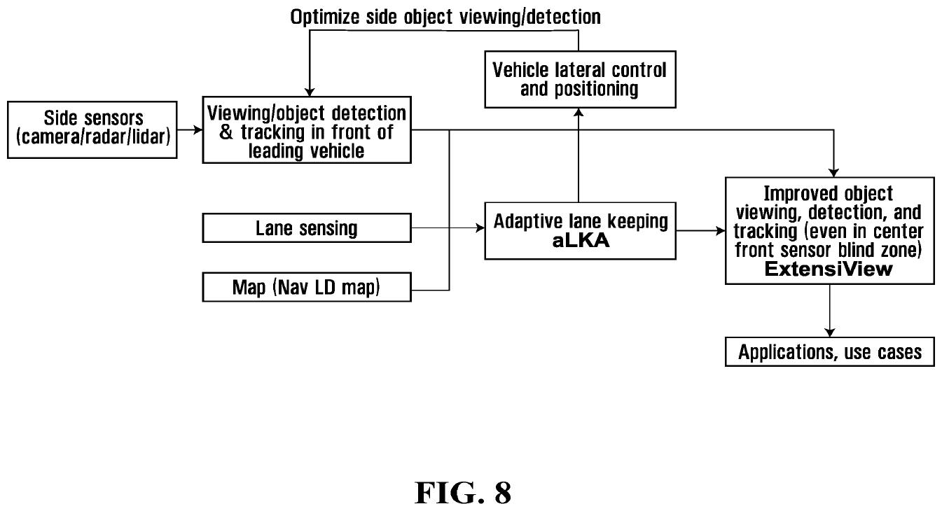

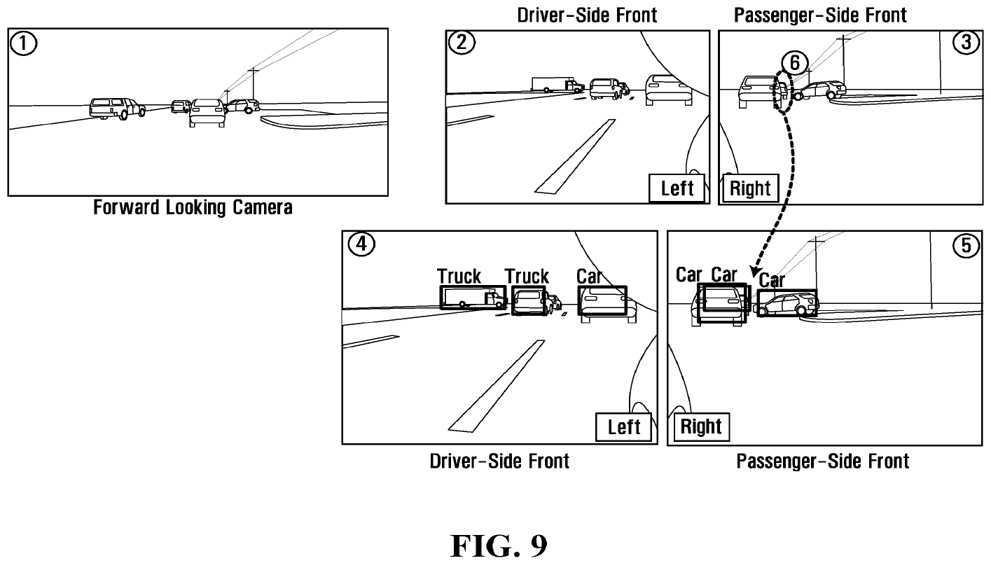

FIG. 8 shows the working flow chart of the Extensiview & aLKA system. The block of “side sensors” represents the side-placed sensors. The “viewing/object detection & tracking in front of leading vehicle” block represents the viewing feature or the perception algorithm of the system. The “lane sensing” block is to provide lane marker detection result for the lateral position of the host vehicle. The “MAP (Nav LD map)” is to provide the route information. For example, if the host vehicle knows the road is curvy, the aLKA can position the vehicle toward the inner lane marker to see a more extensive view for detection as shown in FIG. 6. The “Adaptive Lane Keeping” block calculates the desired lateral position of the host vehicle and sends it to the “Vehicle lateral control and positioning” block to actuate the vehicle to the desired position. As the result, the host vehicle adaptively adjusts its lateral position within the lane to cover more of the blocked view and improve object viewing, detection, and tracking. As soon as side-placed sensors detect any objects, the perception algorithm will classify the objects, and calculate the distances and the velocities of the objects using object tracking such as a KF filter. In addition, if the objects in front of the leading vehicle are vehicles, the algorithm is also able to identify the brake lights' status, and on the like. FIG. 7 and FIG. 9 show Extensiview using surround-view side cameras. It is clear from the right-side surround-view camera in FIG. 7 that there was a dark color SUV in front of the silver SUV. However, neither the front center surround-view camera nor the front center roof mounted camera was able to detect that dark SUV due to the blocked view. The extensive-view system can not only see that dark vehicle, but also detect that object as a vehicle.

Vehicle controllers using information from the Extensiview sensors may include two further functionalities: tracking and prediction. Tracking may be needed because the sensors may not be able to capture the object in front of the leading vehicle all time. When one object is occluded within the FOV of the sensor, it is necessary to continue tracking and estimating the trajectory of that object. Prediction is needed to predict the potential behavior of the leading vehicle. For example, when Extensiview captures that the car in front of the leading vehicle is braking, the prediction block, which resides in the host vehicle path planning and decision module, may calculate the probability of the leading vehicle slowing down or changing lanes, and estimate the potential trajectory of the leading vehicle. In some embodiments, the prediction block may determine multiple potential trajectories and determine a probability of each. The predicted information may then be provided to the host vehicle controller, so that vehicle controller can prepare in ahead of time.

There are multiple potential applications for the proposed Extensiview & aLKA system. In one exemplary embodiment, the proposed systems may be configured to work with an automatic emergency brake (AEB) system to improve vehicle safety. While traditional AEB systems only detect the leading vehicle, the Extensiview system can provide extensive traffic information beyond the leading vehicle, based upon which, the host vehicle can predict the change of the traffic conditions, and inform the AEB system to prepare to brake ahead of time. For example, if any front vehicle conducts a sudden hard brake, the Extensiview system may know quickly and notify the host vehicle controller to prepare for the coming sudden traffic deceleration. This information may be passed to the controller of the AEB system, thereby allowing it to activate the emergency brakes more quickly. In dangerous traffic situations, activating the brakes even a fraction of a second more quickly may prevent a collision.

In another exemplary embodiment, information collected by the proposed systems may be sent to a vehicle powertrain controller to optimize the power output. For instance, if any vehicle in front of the host vehicle is gradually slowing down or speeding up, the system may optimize the power output to improve the energy efficiency and driving comfort. The method of improving vehicle energy efficiency may include, but is not limited to, optimizing energy distribution between different energy sources, and/or optimizing the power output over a time period so that it can reduce radical acceleration or deceleration which is usually inefficient.

The traffic information collected by the proposed systems may also be displayed on the infotainment screen. The information to be displayed may include, but is not limited to, objects' distance from the host vehicle, objects' speed, objects' predicted trajectories, and other information. When there is any change of the traffic, such as, for example, when any front vehicle decelerates or any vehicle switches lanes, the system can alert the driver, thereby improving the driver's ability to make good decisions about accelerating, decelerating, changing lanes, or making other changes.

In alternate embodiments, Extensiview and aLKA systems may be used together or separately. It shall be understood that sensors not limited to cameras. Sensor installation location is not limited to the rearview mirrors, and can be in upper corners behind the windshield, for example, or any other places generally on the sides of the vehicle. The detected object is not limited to vehicles, but mat include any stationary, moveable or moving vehicle, object, person, animal, or the like. The adaptive nature of aLKA includes its adaptive control of vehicle position within a lane to enhance detection of otherwise blocked views. While an application incorporating AEB is described, alternate embodiments may incorporate any other vehicular sensors, systems and actuators. Control parameters of the system and method may be optionally weighted or selectable for improving vehicle energy efficiency, driving comfort, speed, preferential views, or the like. As described above, the system may incorporate a tracking feature to track objects which may become obscured at times, such as objects in front of a leading vehicle. The system may also incorporate a prediction feature to predict the behavior of a leading vehicle or other obstacle.

Exemplary implementations of the systems and methods disclosed herein are now described with reference to FIGS. 5 and 6. These Figures illustrate the function of an aLKA using Extensiview to minimize the blind zone experienced by a host vehicle when driving on a straight road and a curvy road, respectively.

FIG. 5 illustrates a host vehicle 1 outfitted with a sensor system, such as an Extensiview system. The sensor system may include a a side sensor having an FOV 6 and optionally a center sensor having a FOV 5. The sensor system may include other sensors, included sensors which detect the positioning of the host vehicle 1 relative to the lane lines. The sensors may detect a front vehicle 2 in front of the host vehicle 1. As discussed above, the front vehicle 2 may cause blind zones in the FOVs 5, 6 of the sensors. The blind zones could prevent the sensors from detecting a secondary vehicle 3 in front of the front vehicle 2. The information collected by the sensor system may be transmitted to the aLKA, which may determine how the host vehicle 1 should be positioned within the lane. The aLKA may recognize that the front vehicle 2 causes the most significant blind zones when the front vehicle 2 is directly in front of the host vehicle 1 on a straight road. Accordingly, the aLKA may cause the host vehicle 1 to be positioned as far from directly behind the front vehicle 2 as possible while remaining within the lane. This may allow the sensor system to clearly detect the secondary vehicle 3. By keeping the secondary vehicle 3 in the FOV 5, 6 of at least one sensor, the aLKA may enable the host vehicle 1 to respond more quickly to actions of the secondary vehicle 3, such as decelerating or changing lanes. This may increase the safety of the host vehicle 1.

FIG. 6 illustrates a host vehicle 1 in a similar scenario on a curved road. In such a scenario, the aLKA may also consider information about the curvature of the road at the point where the host vehicle 1 is currently located and the curvature of the road in front of the host vehicle 1. The aLKA may act to keep the secondary vehicle in the FOV 3, 2 of one or more sensors. In some embodiments, the aLKA may account for vehicles in front of the secondary vehicle, vehicles behind the host vehicle, vehicles in other lanes, and/or obstacles other than vehicles.

The present disclosure has laid out numerous elements and capabilities which may characterize a vision and driving assist system. It should be noted that any elements may be combined with any other elements, even if not explicitly disclosed herein. Further, a system may not include elements disclosed herein, even if the element is described in combination with other elements.

1. A camera assembly comprising:
a camera;
a means for collecting multiple views disposed on the camera, such that the camera receives visual input from two or more directions.

2. The camera assembly of claim 1, wherein the means for collecting multiple views comprises a prism.

3. The camera assembly of claim 2, wherein the prism is a triangular prism and the camera receives visual input from a first direction and a second direction oriented 180 degrees from the first direction.

4. The camera assembly of claim 2, wherein the prism is a triangular pyramid prism and the camera receives visual input from a first direction, a second direction oriented 180 degrees from the first direction, and a third direction oriented 90 degrees from the first direction and 90 degrees from the second direction.

5. The camera assembly of claim 2, wherein the camera receives the visual input as a single image comprising the visual input from each of the two or more directions.

6. The camera assembly of claim 2, wherein light enters the lens without passing through the prism.

7. The camera assembly of claim 1, wherein the means for collecting multiple views comprises one or more mirrors disposed such that light reflects from the mirrors into the lens and the camera receives visual input from two or more directions.

8. The camera assembly of claim 7, comprising two mirrors oriented such that the camera receives visual input from a first direction and a second direction oriented 180 degrees from the first direction.

9. The camera assembly of claim 7, comprising three mirrors oriented such that the camera receives visual input from a first direction, a second direction oriented 180 degrees from the first direction, and a third direction oriented 90 degrees from the first direction and 90 degrees from the second direction.

10. The camera assembly of claim 7, wherein the camera receives the visual input as a single image comprising the visual input from each of the two or more directions.

11. The camera assembly of claim 7, comprising one mirror and further comprising a rotating mechanism configured to rotate the mirror, such that the mirror reflects light from two or more directions into the lens.

12. The camera assembly of claim 11, wherein the camera receives the visual input as a series of images, each of the images comprising the visual input from one of the two or more directions.

13. The camera assembly of claim 7, wherein light enters the lens without reflecting off of any of the one or more mirrors.

14. The camera assembly of claim 7, further comprising a housing configured to hold the one or more mirrors.

15. The camera assembly of claim 1, wherein the means for collecting multiple views comprises:
a beam splitter configured such that light reflects from the beam splitter into the lens and the camera receives visual input from two or more directions; and
two or more shutters configured to alternately allow and block light from the two or more directions.

16. The camera assembly of claim 15, wherein the beam splitter is configured such that the camera receives visual input from a first direction and a second direction oriented 180 degrees from the first direction.

17. An instrumented vehicle comprising:
a vehicle;
one or more camera assemblies according to claim 1;
a mounting system configured to attach the one or more camera assemblies to the vehicle; and
a controller configured to process visual input received by the camera assemblies and to retrieve information about conditions surrounding the vehicle.

18. The instrumented vehicle of claim 17, wherein the camera assemblies are configured to receive visual input from one or more blind spots of the vehicle.

19. The instrumented vehicle of claim 17, wherein retrieving information comprises identifying obstacles around the vehicle.

20. The instrumented vehicle of claim 19, wherein the controller produces commands based on the identified obstacles.
